(19) United States
(12) Patent Application Publication
(10) Pub. No.: US 2023/0300386 A1
(43) Pub. Date: Sep. 21, 2023

(54) INFORMATION PROCESSING DEVICE, INFORMATION PROCESSING METHOD, AND PROGRAM

(71) Applicant: Sony Group Corporation, Tokyo (JP)

(72) Inventors: Suguru YOKOYAMA, Kanagawa (JP); Hironori HATTORI, Tokyo (JP); Sho OGURA, Kanagawa (JP)

(73) Assignee: Sony Group Corporation, Tokyo (JP)

(21) Appl. No.: 18/013,752

(22) PCT Filed: Jun. 14, 2021
(86) PCT No.: PCT/JP2021/022494

§ 371 Date: Dec. 29, 2022

(30) Foreign Application Priority Data
Jul. 15, 2020 (JP) 2020-121531

(51) Int. Cl. H04N 21/2187; H04N 21/845; G06V 20/40

(52) U.S. Cl. CPC H04N 21/2187; H04N 21/8456; G06V 20/41

(57) ABSTRACT

An information processing device according to the present invention includes a distribution video determination unit that determines a distribution video on the basis of event situation information indicating a situation of a live event at an execution time of determination processing on the distribution video.

### TECHNICAL FIELD

The present invention relates to an information processing device, an information processing method, and a program, and more particularly, to a technology of performing video distribution for a live event such as a sports game.

### BACKGROUND ART

A video obtained by capturing a live event such as a sports game may be distributed to a user who is watching the live event. For example, Patent Document 1 below discloses a calibration for distributing a video so that important scenes are hardly overlooked in view of the fact that it is difficult to simultaneously watch performances such as plays, or acts of a plurality of players at different positions.

### CITATION LIST

### Patent Document

Patent Document 1: Japanese Patent Application Laid-Open No. 2016-082350

### SUMMARY OF THE INVENTION

### Problems to be Solved by the Invention

Meanwhile, a live event such as a sport is required to distribute an appropriate distribution video according to the progress of a game development or the like.

The present technology has been made in view of the above problems, and an object thereof is to distribute a distribution video according to a situation of a live event.

### Solutions to Problems

An information processing device according to the present invention includes a distribution video determination unit that determines a distribution video on the basis of event situation information indicating a situation of a live event at an execution time of determination processing on the distribution video.

The determination processing includes processing of determining generation of a scene video for a scene in response to occurrence of the scene that may be included in the distribution video, processing of determining selection of one or a plurality of scene videos from a plurality of scene videos to generate a distribution video, processing of determining generation of a distribution video using the selected one or plurality of scene videos, processing of determining distribution of the generated distribution video, processing of determining list display of distribution videos, and the like.

Furthermore, for example, in the case of a sports game, the event situation information is a progress situation of the game, a score, a scoring situation, a content or a type of a scene, a situation of a player, a situation of a tool used by a player, a situation of an audience, or the like.

The distribution video determination unit in the information processing device described above may generate the distribution video according to the event situation information.

The distribution video may be generated by performing processing of cutting out and processing of connecting videos of specific scenes from videos of the live event captured by the generation processing execution time, or may be generated by performing processing of selecting one or a plurality of scene videos from the scene videos as partial moving images already generated and processing of connecting the scene videos.

The distribution video determination unit in the information processing device described above may determine a scene included in the distribution video according to the event situation information.

That is, the scene to be distributed is determined from the various scenes so far according to the situation of the live event at the execution time of the various types of determination processing.

The information processing device described above may include an importance level setting unit that sets an importance level for each scene on the basis of the event situation information, and the distribution video determination unit may determine the scene on the basis of the importance level.

As a result, for example, the importance level corresponding to the event situation is set even for a similar scene.

The distribution video determination unit in the information processing device described above may select the distribution video according to the event situation information from among a plurality of candidate videos selectable as the distribution video.

As a result, at the time of distribution, it is only necessary to determine the distribution video from the already generated candidate videos.

The information processing device described above may include an importance level setting unit that sets an importance level for each of the plurality of candidate videos on the basis of the event situation information, and the distribution video determination unit may select the distribution video on the basis of the importance level.

As a result, according to the event situation, for example, the importance level is set to the candidate video according to the progress of the game or the game development.

In the information processing device described above, the event situation information may be progress information indicating a degree of progress with respect to a total time length of the live event.

The progress information may be, for example, elapsed time information from the start time of the live event, information regarding a time segment set for each predetermined time length in sports, or a consumed rate of the event in the live event.

The information regarding the predetermined time segment in sports is, for example, information on the first half (45 minutes), the second half (45 minutes), or the like in soccer, or the like. Furthermore, the information may be interval information (for example, halftime provided during the entire second half, or the like) provided for each section.

In the information processing device described above, the event situation information may be information regarding a consuming or consumed time segment among time segments determined in advance in the live event, and the distribution video determination unit may determine the distribution video according to the last consumed time segment or the consuming time segment.

The time segment is, for example, information on the top of the first inning, the bottom of the seventh inning, or the like in baseball, information on the first inning (top and bottom of the first inning) or the like, information on a first half (first inning to third inning), a middle stage (fourth inning to sixth inning), a final stage (seventh inning to ninth inning), and the like and information on a second set, a third set, or the like in volleyball.

Then, for example, in a case where the distribution of the distribution video is determined during consumption of the bottom of the fifth inning in baseball, the distribution video for the bottom of the fifth inning being consumed may be distributed, the distribution video for the fifth inning being consumed (that is, the distribution video including the scenes of the top of the fifth inning and the bottom of the fifth inning) may be distributed, the distribution video for the top of the fifth inning consumed last may be distributed, or the distribution video for the fourth inning consumed last (that is, the fifth inning is being consumed) may be distributed.

In the information processing device described above, the event situation information may be information regarding a time segment of an interval in the live event, and the distribution video determination unit may determine a distribution video according to a time segment consumed immediately before the interval.

The time of the interval can be considered as an appropriate time zone for distributing the distribution video because the event to be viewed is inactive.

In the information processing device described above, the event situation information may be information regarding a scene type of a scene corresponding to the determination processing in the live event.

As a result, the distribution video is determined according to the type of the scene corresponding to the determination processing or the like.

The information processing device described above may include an importance level setting unit that sets an importance level for a trigger scene that is a trigger for execution of the determination processing on the distribution video, and the distribution video determination unit may determine the distribution video by selecting a scene including the trigger scene on the basis of the importance level.

The trigger scene refers to, for example, a dead ball scene that causes a suspension scene in a case where a dead ball occurs in baseball and the game is suspended. If no dead ball scene occurs, no suspension scene occurs, and distribution of the distribution video is not performed. In other words, it can be said that the scene is a trigger for distributing the distribution video.

In a case where the importance level of the trigger scene, which is the scene that triggered the distribution of the distribution video, is high, the distribution video including the trigger scene is generated and distributed.

In the information processing device described above, the distribution video determination unit may determine the scene on the basis of an occurrence time and the importance level for each scene.

In a case where a scene other than the trigger scene is selected and the distribution video is generated, not only the importance level of the scene but also the occurrence time is taken into consideration. Furthermore, also in a case where the distribution video that does not include the trigger scene is selected from the plurality of distribution videos, the selection may be performed on the basis of the importance level or the occurrence time of the scene included in the distribution video.

The information processing device described above may include a time length setting unit that sets a reproduction time length of the distribution video on the basis of the event situation information, and the distribution video determination unit may determine the distribution video on the basis of the reproduction time length.

The time length allocated to the viewing of the distribution video may vary depending on the situation of the live event. Specifically, taking soccer as an example, an appropriate reproduction time length of the distribution video to be distributed to the user is different between a case where the distribution video is browsed in a relatively long free time such as half time and a case where the distribution video is browsed in a relatively short time such as while the progress of the game is suspended due to the yellow card.

According to this configuration, the reproduction time length is set on the basis of the event situation information.

The time length setting unit in the information processing device described above may set the reproduction time length of the distribution video to be distributed to in a time segment of an interval in the live event according to a length of the interval.

For the distribution video to be distributed at the interval, it is desirable to provide the distribution video having a reproduction time length according to the time length of the interval to the user.

The information processing device described above may include a processing start control unit that determines an execution timing of the determination processing according to the event situation information.

As a result, execution timings of processing of determining generation of a scene video as a partial moving image that can be included in a distribution video, processing of determining selection of one or a plurality of scene videos from a plurality of scene videos, processing of determining generation of a distribution video, processing of determining distribution of a distribution video, processing of determining list display of distribution videos, and the like are determined according to the situation of the live event.

The processing start control unit in the information processing device described above may determine a switching timing of a time segment determined in advance in the live event as the execution timing.

As a result, it is possible to distribute the distribution video and the like at a timing suitable for the user.

The processing start control unit in the information processing device described above may determine the execution timing according to a scene type of a scene that occurs in the live event.

As a result, it is possible to distribute the distribution video at an appropriate timing according to the scene type.

In the information processing device described above, the event situation information may be generated on the basis of a captured image obtained by capturing the live event.

The event situation information is various types of information indicating the situation of the live event. According to this configuration, the situation of the live event is estimated by analyzing the captured image. That is, the estimation processing is executed as to what kind of scene the currently captured scene is.

An information processing method according to the present invention is an information processing method executed by an information processing device, the information processing method including a step of determining a distribution video on the basis of event situation information indicating a situation of a live event at an execution time of determination processing on the distribution video.

A program according to the present invention is a program causing a computer to execute processing of determining a distribution video on the basis of event situation information indicating a situation of a live event at an execution time of determination processing on the distribution video.

### BRIEF DESCRIPTION OF DRAWINGS

FIG. 1 is a diagram illustrating a configuration example of a video distribution system according to an embodiment of the present invention.

FIG. 2 is a diagram illustrating a hardware configuration of an information processing device.

FIG. 3 is a functional block diagram of a video distribution server.

FIG. 4 is a diagram illustrating a first example of a flow of data in the video distribution system.

FIG. 5 is a diagram illustrating a second example of a flow of data in the video distribution system.

FIG. 6 is a diagram illustrating a third example of a flow of data in the video distribution system.

FIG. 7 is an explanatory diagram of a first example of a distribution target.

FIG. 8 is an explanatory diagram of a second example of a distribution target.

FIG. 9 is an explanatory diagram of a third example of a distribution target.

FIG. 10 is an explanatory diagram of a fourth example of a distribution target.

FIG. 11 is an example of a flowchart of a first processing example.

FIG. 12 is an example of a flowchart of a second processing example.

FIG. 13 is an example of a flowchart of a third processing example.

FIG. 14 is an example of a flowchart of a fourth processing example.

### MODE FOR CARRYING OUT THE INVENTION

Hereinafter, embodiments will be described in the following order.
<1. System Configuration>
<2. Hardware Configuration of Computer Device>
<3. Functional Configuration of Video Distribution Server>
<4. Flow of Data in Video Distribution System>
<4-1. First Example>
<4-2. Second Example>
<4-3. Third Example>
<5. Distribution Target>
<5-1. First Example of Distribution Target>
<5-2. Second Example of Distribution Target>
<5-3. Third Example of Distribution Target>
<5-4. Fourth Example of Distribution Target>
<6. Processing Example>
<6-1. First Processing Example>
<6-2. Second Processing Example>
<6-3. Third Processing Example>
<6-4. Fourth Processing Example>
<7. Modification>
<8. Summary>
<9. Present Technology>
<1. System Configuration>

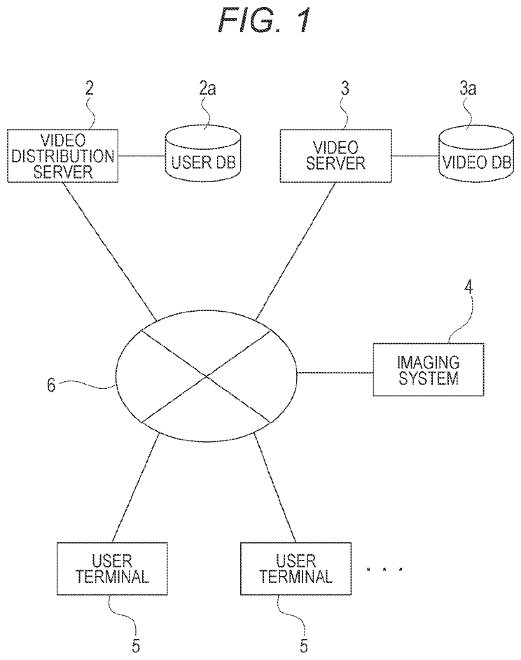

A configuration of a video distribution system 1 including a video distribution server according to the present embodiment will be described with reference to FIG. 1.

Note that the video distribution system 1 distributes various videos regarding a live event to a user terminal used by a user. The live event to be distributed may be various events such as a sports game, a concert, a play, an opera, a lecture, and a conference. In the following description, an example of distributing a video obtained by capturing a game of sports such as baseball, soccer, and tennis will be mainly described.

The video distribution system 1 includes a video distribution server 2, a video server 3, an imaging system 4, and a user terminal 5, and includes a communication network 6 that mutually connects these terminal devices or information processing devices.

The video distribution server 2 is a server device that provides a service of acquiring a video from the video server 3 and distributing the video to the user terminal 5. As the video (distribution video) distributed to the user terminal 5, there are various videos such as a highlight video (digest video), a replay video, and a delay video of a live event.

The video distribution server 2 distributes the distribution video according to the situation of the live event. The situation of the live event is a progress situation of a sports game, a score situation, a content (scene type) of a scene, a situation of a player, a situation of a tool used by a player, a situation of an audience, and the like.

The information on the progress situation is, for example, information indicating how much time segment of a time segment (such as the top of the first inning or the bottom of the first inning in baseball) determined in advance is consumed or has been consumed, information indicating a degree of progress with respect to a total time length (90 minutes in soccer), or the like.

As the distribution video according to the situation of the live event, for example, in a case where a scoring scene occurs, the distribution video including the scoring scene is distributed according to the situation of the live event in which the scoring scene occurs. Furthermore, at the time of the interval provided between the first half and the second half, the highlight video in the previous time zone (that is, the first half) is distributed as the distribution video according to the situation of the live event in which the time zone of the interval has arrived.

In the following description, information indicating the situation of the live event will be referred to as “event situation information”. The event situation information is generated, for example, by analyzing a captured image captured by the imaging system 4.

Furthermore, the video distribution server acquires information (user information) of the user who uses the user terminal 5 in order to select an appropriate distribution video for each user, and performs each processing.

Moreover, the video distribution server 2 also functions as a user information management server that manages user information. For this purpose, the video distribution server 2 manages a user database (DB) 2a in which user information is stored.

The user DB 2a stores a user identification (IDs) that can uniquely specify a user, a password, information regarding liking/preference, a distribution history of a distribution video, and the like. Furthermore, an e-mail address, an address, a name, and the like used by the user may be stored.

The video server 3 is a server device that manages captured image data (still image data and movie data) uploaded from the imaging system 4. The video server 3 manages the video DB 3a in which the uploaded captured image data is stored.

The video server 3 receives the information specifying the movie data and the time code information stored in the video DB 3a, and performs processing of transmitting the partial moving image data corresponding to the time code information to the video distribution server 2.

The imaging system 4 includes one or a plurality of imaging devices and microphones installed in or near a venue where a live event is held. The captured image data captured by each imaging device is uploaded to the video server 3.

Various configurations of the communication network 6 can be considered. For example, the Internet, an intranet, an extranet, a local area network (LAN), a community antenna television (CATV) communication network, a virtual private network, a telephone line network, a mobile communication network, a satellite communication network, and the like are assumed as the communication network 6.

Furthermore, various examples are also assumed for transmission media constituting the whole or a part of the communication network 6. For example, the present technology can be used in a wired manner such as Institute of Electrical and Electronics Engineers (IEEE) 1394, a universal serial bus (USB), power line conveyance, or a telephone line, or in a wireless manner such as infrared rays such as infrared data association (IrDA), Bluetooth (registered trademark), 802.11 radio, a mobile phone network, a satellite line, or a terrestrial digital network.

Furthermore, in a case where the distribution video distributed by the video distribution server 2 is reproduced on the user terminal 5, a content delivery network (CDN) may be used.

The video distribution system 1 includes the video distribution server 2, the video server 3, the imaging system 4, the user terminal 5, and the like described above via the communication network 6, so that the distribution video can be provided to the user terminal r.

<2. Hardware Configuration of Computer Device>

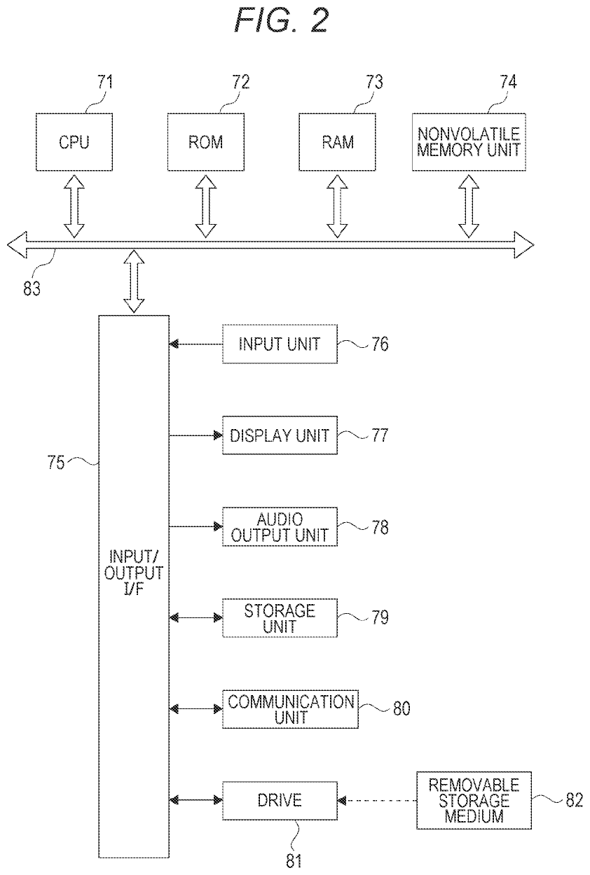

A hardware configuration of the video distribution server 2, the video server 3, the imaging system 4, the user terminal 5, and various DBs included in the video distribution system 1 will be described with reference to FIG. 2. Note that each information processing device does not need to include all the configurations described below, and may include only a part thereof.

A CPU 71 of the information processing device executes various processes in accordance with a program stored in a nonvolatile memory unit 74 such as a ROM 72 or, for example, an electrically erasable programmable read-only memory (EEP-ROM), or a program loaded from a storage unit 79 to a RAM 73. The RAM 73 also appropriately stores data and the like necessary for the CPU 71 to execute various processes.

The CPU 71, the ROM 72, the RAM 73, and the nonvolatile memory unit 74 are connected to one another via a bus 83. An input/output interface 75 is also connected to the bus 83.

An input unit 76 including an operator and an operation device is connected to the input/output interface (I/F) 75.

For example, as the input unit 76, various operators and operation devices such as a keyboard, a mouse, a key, a dial, a touch panel, a touch pad, and a remote controller are assumed.

An operation of the user is sensed by the input unit 76, and a signal corresponding to the input operation is interpreted by the CPU 71.

In addition, a display unit 77 including an LCD, an organic EL panel, or the like, and an audio output unit 78 including a speaker or the like are connected to the input/output interface 75 integrally or separately.

The display unit 77 is a display unit that performs various displays, and includes, for example, a display device provided in a housing of a computer device, a separate display device connected to the computer device, or the like.

The display unit 77 executes display of an image for various types of image processing, a moving image to be processed, and the like on a display screen on the basis of an instruction from the CPU 71. In addition, the display unit 77 displays various operation menus, icons, messages, and the like, that is, displays as a graphical user interface (GUI) on the basis of an instruction from the CPU 71.

In some cases, a storage unit 79 including a hard disk, a solid-state memory, or the like, and a communication unit 80 including a modem or the like are connected to the input/output interface 75.

The communication unit 80 performs communication processing via a transmission path such as the Internet, wired/wireless communication with various devices, bus communication, and the like.

A drive 81 is also connected to the input/output interface 75 as necessary, and a removable storage medium 82 such as a magnetic disk, an optical disk, a magneto-optical disk, or a semiconductor memory is appropriately mounted.

A data file such as an image file, various computer programs, and the like can be read from the removable storage medium 82 by the drive 81. The read data file is stored in the storage unit 79, and images and sounds included in the data file are output by the display unit 77 and the audio output unit 78. Furthermore, a computer program and the like read from the removable storage medium 82 are installed in the storage unit 79 as necessary.

In this computer device, for example, software for processing of the present embodiment can be installed via network communication by the communication unit 80 or the removable storage medium 82. Alternatively, the software may be stored in advance in the ROM 72, the storage unit 79, or the like.

The CPU 71 performs processing operations on the basis of various programs, thereby executing information processing and communication processing necessary as the video distribution server 2, the video server 3, the imaging system 4, the user terminal 5, and various DBs.

Note that the information processing device constituting the video distribution server 2, the video server 3, the imaging system 4, the user terminal 5, and the various DBs are not limited to the single computer device as illustrated in FIG. 2, and may be configured by systematizing a plurality of computer devices. The plurality of computer devices may be systematized by a LAN or the like, or may be arranged in a remote place by a VPN or the like using the Internet or the like. The plurality of information processing devices may include an information processing device as a server group (cloud) usable by a cloud computing service.

<3. Functional Configuration of Video Distribution Server>

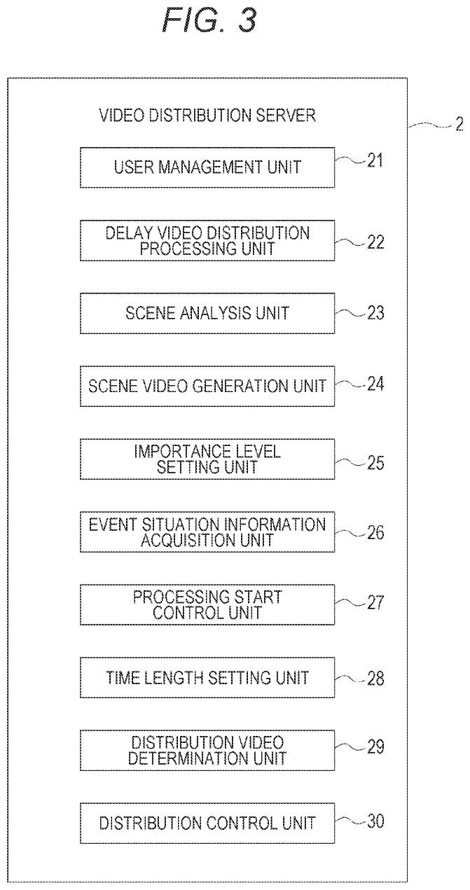

When the CPU 71 of the video distribution server 2 operates on the basis of the program, the CPU 71 of the video distribution server 2 functions as a user management unit 21, a delay video distribution processing unit 22, a scene analysis unit 23, a scene video generation unit 24, an importance level setting unit 25, an event situation information acquisition unit 26, a processing start control unit 27, a time length setting unit 28, a distribution video determination unit 29, a distribution control unit 30, and the like illustrated in FIG. 3.

The user management unit 21 performs various types of processing for managing user information of users who use various services provided by the video distribution system 1. Specifically, the user management unit 21 performs user registration processing, login/logoff processing, user information change processing and update processing, user information deletion processing, user information transmission processing, and the like.

Furthermore, by receiving information from the user terminal 5 at the timing when the user arrives at the venue or at the timing when the user enters the venue, processing of detecting that the user has started watching the live event or the like is also executed.

Note that the user to be managed may include not only an authorized user who has performed member registration but also a guest user who uses a service without performing member registration.

The delay video distribution processing unit 22 performs processing of distributing the delay video of the live event to the user terminal 5. In the following example, while the game is in progress, that is, while the game is in play, a delay video with a delay of 10 seconds is distributed to the user terminal 5, thereby coping with the user's scene missing.

The delay video distribution processing unit 22 stops distribution of the delay video in a case where it is necessary to distribute a video other than the delay video to the user terminal 5. Specifically, in a case where the distribution video determination unit 29 to be described later determines to distribute a video of a specific scene to the user terminal 5, a stop request of the delay video distribution is transmitted to the delay video distribution processing unit 22. The delay video distribution processing unit 22 stops distribution of the delay video in response to reception of the stop request. Note that the delay video distribution processing unit 22 also stops distribution of the delay video in a case where the stop request of distribution of the delay video is transmitted from the user terminal 5.

The scene analysis unit 23 performs analysis processing such as image analysis on the video uploaded to the video server 3 in real time. In the analysis processing, processing of recognizing a subject, processing of specifying and classifying a scene, and the like are executed.

The scene analysis unit 23 performs processing of adding information on the result of the analysis processing to each scene as tag information. The tag information to be added is, for example, tag information indicating a specified scene type, tag information indicating player information appearing as a subject, or the like. Furthermore, the scene analysis unit 23 may generate scene situation information according to the analysis result. For example, by analyzing video data on which various superimposed images (telops or the like) are superimposed for broadcasting, the superimposed image may be extracted to generate the scene situation information.

The scene video generation unit 24 generates a partial video for each scene as a scene video according to the analysis result of the scene analysis unit 23. In the generation of the scene video, the scene video data that is physically different moving image data from the uploaded captured image data may be generated and stored in the video DB 3a of the video server 3, or the scene video may be cut out at any time by specifying and managing a time code indicating the start and end of the scene.

Note that the scene video generation unit 24 may generate a plurality of scene videos for one scene. For example, each of a long-version scene video having a long reproduction time length and a short-version scene video may be generated. These scene videos are appropriately selected according to the reproduction time length of the distribution video distributed to the user.

The importance level setting unit 25 sets the importance level for each scene according to the analysis result of the scene analysis unit 23. The importance level is an index value added so as to have a higher numerical value as the importance is higher, and for example, a high importance level is added to a scoring scene, an important scene that determines the flow of a game, and the like.

Note that the importance level may change according to the progress of the game (progress of the live event) even in the same scene. For example, suppose that 50 points (0 to 100 points) are added to a scoring scene in the early stage of the game as the importance level at the beginning when the scene occurs. However, as a result of the progress of the game by the end of the game, in a case where the only scoring scene of the game is the scene, the importance level is changed from 50 points to 80 points. In this manner, the importance level may be variable.

Furthermore, the importance level may change for each user. For example, the importance level may be changed on the basis of information regarding the user's liking/preference, or the importance level may be managed by a basic importance level and a coefficient. For example, the importance level may be calculated by multiplying a basic importance level, which is a numerical value common to all users determined from a scene type, a game development, or the like, by a coefficient for each user determined according to the user's liking/preference.

The event situation information acquisition unit 26 acquires event situation information indicating the situation of the live event. As the event situation information, information generated by the scene analysis unit 23 as tag information of a scene or the like may be acquired, or may be acquired from an information processing device outside the video distribution system 1. Examples of the acquisition from the external information processing device include acquisition from information posted on a social networking service (SNS) server device, acquisition of a progress table of an event from a web server, and the like, for example. The event situation information may be acquired from an external information processing device similarly in each example described later.

The processing start control unit 27 controls start timing of various types of processing for distributing the distribution video to the user terminal 5. The various types of processing include, for example, processing of determining distribution of a distribution video, selection processing of generating a distribution video from various scene videos as partial moving images, distribution processing of a distribution video, processing of presenting a list of candidate videos as distribution candidates to the user, and the like.

Each of the following examples will be described using a distribution timing of a distribution video which is an example of a start timing of various types of processing.

The processing start control unit 27 may manage the start timing of each processing using flag information. For example, in a case where it is decided that the distribution timing of the highlight video arrives, the highlight video determination trigger is set to ON.

The start timing (or execution timing) of each processing is important in generating and distributing the distribution video. This is because the video distribution server 2 provides the user with an appropriate distribution video according to the event situation information such as the game development and the type of scene that occurred immediately before. That is, when the timing of generating the distribution video and the distribution timing are different, the appropriate distribution video is also different.

The processing start control unit 27 controls the start timing of various types of processing for the distribution video in order to provide the appropriate distribution video to the user at an appropriate timing.

For example, the processing start control unit 27 may control the execution timing of various types of processing according to the timing at which the user activates the user terminal 5 such as a mobile phone or the timing at which the user activates specific application software in the user terminal 5.

Furthermore, in a case where the event situation information is acquired from the information posted on the SNS server device, for example, the start timing may be determined in a case where the number of posts including the name of the player exceeds a threshold value.

The time length setting unit 28 performs processing of setting the reproduction time length of the distribution video. The reproduction time length may be set from the length of time estimated to be allocated to viewing of the distribution video by the user, or may be set from the time length of the interval (intermission) of the live event. Alternatively, in a case where a game is suspended due to occurrence of a specific scene in a live event, or the like, the reproduction time length may be set from an average suspension time for each scene type (for each type of suspension scene), for example. That is, the reproduction time length may be set according to the event situation information.

The distribution video determination unit 29 performs processing of determining the distribution video on the basis of the event situation information indicating the situation of the live event, the importance level, and the user information. The determination of the distribution video may be performed by selecting one or a plurality of scene videos from a plurality of scene videos prepared in advance, or may be performed by preparing a plurality of distribution candidate videos obtained by connecting a plurality of scenes and selecting one video from the plurality of distribution candidate videos as the distribution video.

The distribution control unit 30 performs processing for distributing the distribution video determined by the distribution video determination unit 29 to the user terminal 5.

<4. Flow of Data in Video Distribution System>

A flow of data transmitted and received between the video server 3, the imaging system 4, and the user terminal 5 included in the video distribution system 1 and each unit included in the video distribution server 2 will be described with reference to the attached drawings.

### 4-1. First Example

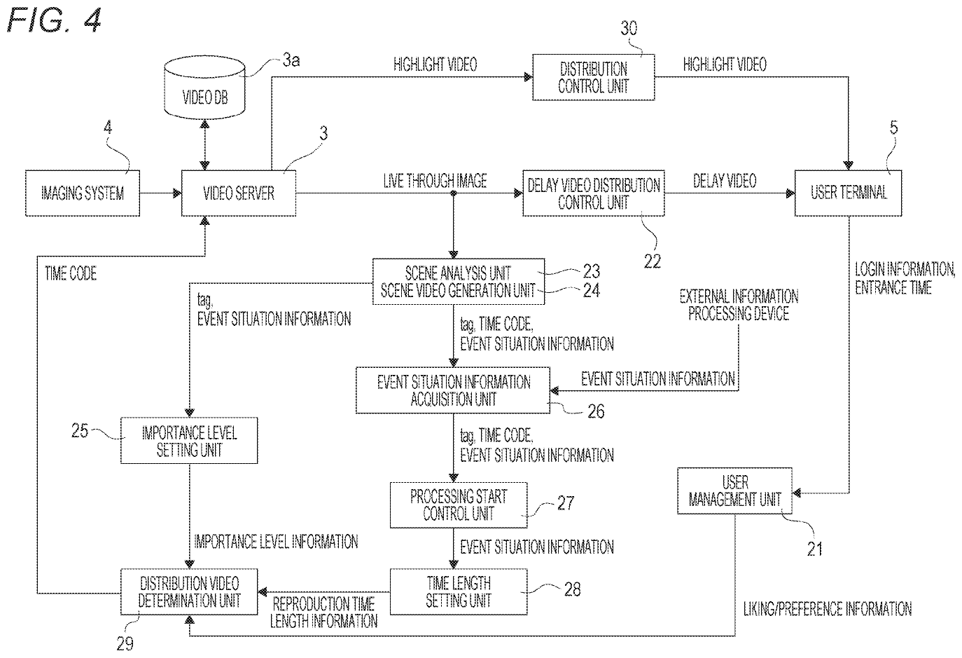

A flow of data in the first example will be described with reference to FIG. 4. In the first example, the tag information and the time code information for each scene are accumulated in the distribution video determination unit 29. Then, in a case where the distribution of the distribution video is determined, the distribution video is determined in the distribution video determination unit 29 according to the accumulated tag information, time code information, and reproduction time length.

A flow of each data will be specifically described. The user terminal 5 transmits the entrance time information to the user management unit 21 when the user moves to the vicinity of the venue where the live event is held or when the user enters the venue. Furthermore, the user terminal 5 transmits information such as a browsing history and a search history, and information input by the user to the user management unit 21 as the liking/preference information. The liking/preference information may be acquired before the start of the live event such as at the time of member registration.

The user management unit 21 manages user's liking/preference information. The managed liking/preference information is appropriately provided to the distribution video determination unit 29.

The captured image data captured by the imaging system 4 is uploaded to the video server 3 and accumulated in the video DB 3a. Such captured image data may include, for example, a video or the like viewed by a video assistant referee (VAR) to confirm a game.

Furthermore, the captured image data captured by the imaging system 4 is transmitted as a live through image to the delay video distribution processing unit 22. The delay video distribution processing unit 22 performs processing of generating a delay video of a predetermined number of seconds and distributing the delay video to the user terminal 5. The number of delay seconds of the delay video may be determined in advance or may be specified by the user.

By performing such processing, the delay video is delivered to the user terminal 5 at the normal time.

The live through image output from the video server 3 is also input to the scene analysis unit 23 and the scene video generation unit 24.

The scene analysis unit 23 analyzes the live through image to add scene type information indicating a type of a scene as tag information. Furthermore, the scene analysis unit 23 may add, as the tag information, information (for example, player name) specifying a player appearing in the scene or the like. Moreover, the scene analysis unit 23 generates event situation information on the basis of the analysis result. As described above, the event situation information is information indicating the situation of the live event, and is information indicating the progress of the game, information indicating which team is dominant, score information, or the like.

The scene video generation unit 24 detects an in-point indicating the start of the detected scene and an out-point indicating the end of the scene, and specifies a video section to be cut out.

The event situation information and the tag information added to each scene are output from the scene analysis unit 23 to the importance level setting unit 25. The importance level setting unit 25 sets the importance level for each scene on the basis of the tag information or the event situation information (or on the basis of any one of the tag information and the event situation information). The importance level set here may be the same regardless of the user, or may be different for each user. Furthermore, the importance level set by the importance level setting unit 25 is the same regardless of the user, but the distribution video determination unit 29 may reset the importance level for each user using a coefficient for each user when selecting the scene video.

The set importance level is output to the distribution video determination unit 29. In the distribution video determination unit 29, determination processing of the distribution video is performed on the basis of the importance level.

On the other hand, as the analysis result by the scene analysis unit 23, at least a part of the tag information, the time code information, and the event situation information is output to the event situation information acquisition unit 26. The event situation information acquisition unit 26 outputs the received event situation information, tag information, and time code information to the processing start control unit 27. Note that the event situation information acquisition unit 26 also outputs event situation information acquired from an external information processing device to the processing start control unit 27.

The processing start control unit 27 determines whether or not to distribute the distribution video to the user on the basis of at least a part of the input tag information, time code information, and event situation information. In a case where the distribution of the distribution video is determined, the processing start control unit 27 performs processing of causing the time length setting unit 28 to set the reproduction time length of the distribution video. The time length setting unit 28 sets the reproduction time length according to the event situation information, and outputs the reproduction time length to the distribution video determination unit 29.

In order to determine the distribution video based on the reproduction time length information, the liking/preference information of the user, the importance level information, and the event situation information, the distribution video determination unit 29 executes processing of selecting scene videos, processing of connecting scene videos, processing of selecting distribution videos from a plurality of candidate videos, and the like. The distribution video determined by these processes corresponds to the event situation information such as the progress of the game at the processing start timing determined by the processing start control unit 27.

Note that, in a case where the distribution video is selected (or generated) so as to include the scene video selected on the basis of the importance level of the scene video, the total value of the importance levels of the scene videos included in the candidate videos may be set to be high, or the average importance level of the scene videos included in the candidate videos may be set to be high. In the former case, there is a case where a candidate video including three scene videos with medium importance level is selected as the distribution video rather than a candidate video including two scene videos with high importance level. In the latter case, a candidate video including two scene videos having a higher importance level is selected as the distribution video rather than a candidate video including three scene videos having a medium importance level.

Note that, in a case where a plurality of candidate videos including one or a plurality of scene videos is prepared and a distribution video is selected from the plurality of candidate videos, the importance level setting unit 25 may set the importance level of each candidate video.

Note that the distribution video may be selected without using the importance level. For example, the candidate video closest to the set reproduction time length may be selected as the distribution video, or the candidate video including the video of the specific scene such as the scene designated by the user may be selected as the distribution video.

After determining the distribution video, the distribution video determination unit 29 transmits the time code information to the video server 3. The video server 3 transmits the highlight video to the distribution control unit 30 on the basis of the received time code information.

The distribution control unit 30 performs control to distribute the received highlight video to the user terminal 5. Note that the information for specifying the user terminal 5 as the distribution target may be acquired directly or indirectly from the distribution video determination unit 29, or may be acquired from the user management unit 21 or the like.

By each unit performing the processing as illustrated in FIG. 4, the delay video is distributed to the user terminal 5, and the highlight video is distributed at an appropriate timing according to the game development. The user can prevent the user from missing a scene by appropriately viewing the delay video, and can confirm an important scene or the like by viewing a separately distributed highlight video.

### 4-2. Second Example

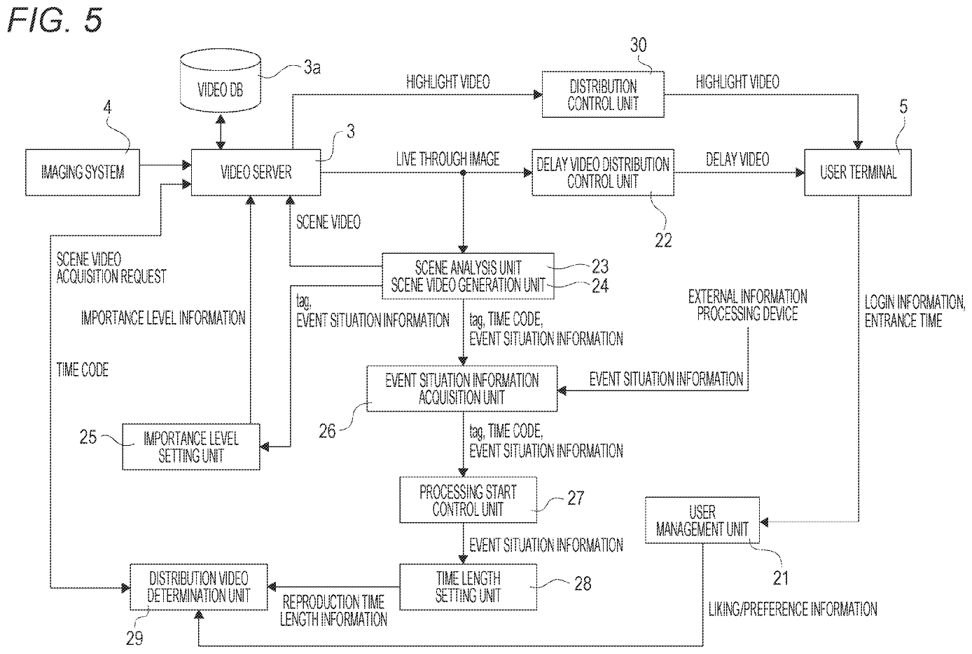

A flow of data in the second example will be described with reference to FIG. 5. In the second example, the video server 3 manages the scene video and the importance level information.

Note that description of a flow of data similar to that in the first example will be omitted as appropriate.

The captured image data captured by the imaging system 4 is accumulated in the video server 3 and distributed as a delay video to the user terminal 5 via the delay video distribution processing unit 22.

Furthermore, the live through image output from the video server 3 is output to the scene analysis unit 23 and the scene video generation unit 24.

The scene analysis unit 23 performs analysis processing on the live through image. The analysis result is output to the scene video generation unit 24, and the scene video generation unit 24 generates a scene video for each scene. The generated scene video is transmitted to the video server 3.

At this time, the information transmitted from the scene video generation unit 24 to the video server 3 may be moving image data as a scene video, or time code information of an in-point and an out-point for specifying which scene the scene video belongs to.

The video server 3 manages the scene video generated by the scene video generation unit 24.

The scene analysis unit 23 outputs tag information indicating a scene type to the importance level setting unit 25. The importance level setting unit 25 sets the importance level for each scene and outputs the importance level to the video server 3.

The video server 3 manages the scene video and the importance level information in association with each other.

Note that the importance level setting unit 25 may acquire the liking/preference information of the user from the user management unit 21 and set the importance level for each user.

The analysis result by the scene analysis unit 23 is also output to the event situation information acquisition unit 26. The event situation information acquisition unit 26 appropriately outputs various information input from the scene analysis unit 23 and event situation information acquired from an external information processing device to the processing start control unit 27.

The processing start control unit 27 determines whether or not to distribute the distribution video to the user according to the scene type information, the time code information, and the event situation information as the analysis result. This determination may be made using all the received information, or may be made using a part of the received information.

In a case where the distribution of the distribution video is determined, a setting request of the reproduction time length is transmitted from the processing start control unit 27 to the time length setting unit 28.

In response to the reception of the request, the time length setting unit 28 sets the reproduction time length according to the event situation information, and outputs the reproduction time length to the distribution video determination unit 29.

Upon receiving the information on the reproduction time length, the distribution video determination unit 29 generates the distribution video according to the reproduction time length. Specifically, the scene video and the importance level information generated so far are acquired from the video server 3. Moreover, the distribution video determination unit 29 acquires liking/preference information regarding the user from the user management unit 21, and selects the scene video in consideration of the importance level information, thereby generating the distribution video. Note that the distribution video generated at this time is assumed to fall within the reproduction time length set by the time length setting unit 28.

The distribution video determination unit 29 transmits time code information for specifying the determined distribution video to the video server 3. The video server 3 specifies the distribution video determined according to the received time code information, generates the highlight video as the distribution video, and distributes the distribution video to the user terminal 5 via the distribution control unit 30.

### 4-3. Third Example

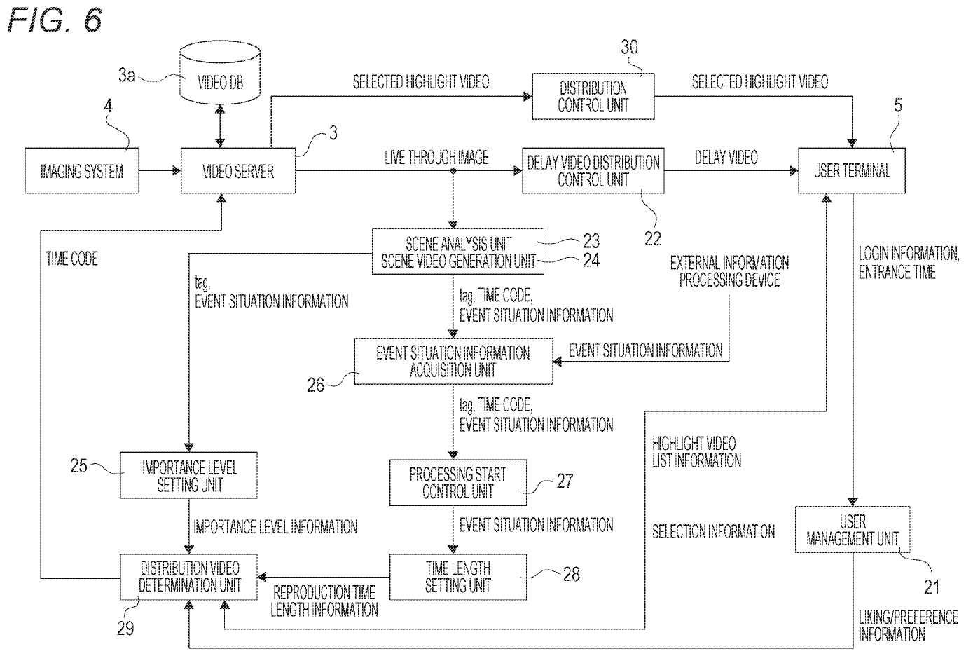

A flow of data in the third example will be described with reference to FIG. 6. In the third example, a plurality of distribution video candidates (lists) is transmitted to the user terminal 5. Then, the distribution video is distributed on the basis of the selection of the user.

Note that description of data flows similar to those in the first example and the second example will be omitted as appropriate.

The captured image data captured by the imaging system 4 is accumulated in the video server 3 and distributed as a delay video to the user terminal 5 via the delay video distribution processing unit 22.

Furthermore, the live through image output from the video server 3 is output to the scene analysis unit 23 and the scene video generation unit 24.

The scene analysis unit 23 performs analysis processing on the live through image. The analysis result includes tag information such as a scene type and event situation information, and is transmitted to the importance level setting unit 25.

The importance level setting unit 25 sets the importance level for each scene on the basis of the tag information and the event situation information, and transmits the importance level to the distribution video determination unit 29.

Furthermore, the analysis result of the scene analysis unit 23 is also output to the scene video generation unit 24. The scene video generation unit 24 generates time code information for specifying a scene.

The tag information, the time code information, and the event situation information are output to the event situation information acquisition unit 26. The event situation information acquisition unit 26 outputs various information input from the scene analysis unit 23 and event situation information acquired from an external information processing device to the processing start control unit 27.

The processing start control unit 27 determines whether or not to distribute the distribution video to the user on the basis of at least a part of the received various types of information.

In a case where the distribution of the distribution video is determined, the processing start control unit 27 performs processing of causing the time length setting unit 28 to set the reproduction time length of the distribution video. The time length setting unit 28 sets the reproduction time length according to the event situation information, and outputs the reproduction time length to the distribution video determination unit 29.

The distribution video determination unit 29 generates a plurality of candidate videos of the distribution video on the basis of the liking/preference information, the importance level information, the reproduction time length, and the event situation information of the user acquired from the user management unit 21, and transmits the generated candidate videos to the user terminal 5 as a highlight video list. The transmission of the highlight video list may be executed via the distribution control unit 30.

Note that the scene video may be generated in advance without using the information acquired from the user management unit 21, and the reproduction order, combination, display mode, display position, display order of the candidate videos on the list, and the like of the scene videos may be determined according to the information such as the liking/preference information, the importance level information, the reproduction time length, and the event situation information of the user at the time of transmitting the highlight video list.

The user selects one or a plurality of highlight videos from the highlight video list displayed on the display unit of the user terminal 5. In response to this, the user terminal 5 transmits information for specifying the selected highlight video to the distribution video determination unit 29.

The distribution video determination unit 29 determines a distribution video on the basis of the received selection information, and transmits time code information to the video server 3.

The video server 3 generates a highlight video as a distribution video according to the received time code information and distributes the distribution video to the user terminal 5 via the distribution control unit 30.

<5. Distribution Target>

The video distribution server 2 selects a scene to be distributed or a section (time zone) to be distributed according to the event situation information by each unit executing processing.

Here, a specific example of the selection will be described.

### 5-1. First Example of Distribution Target

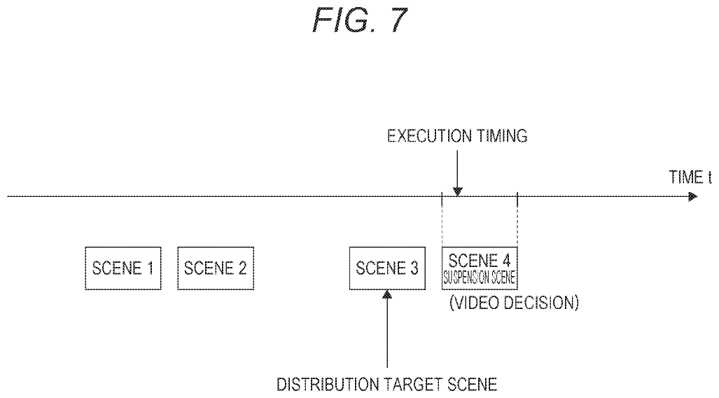

In the first example of the distribution target, the distribution of the distribution video is determined in the time zone in which the play is suspended or the time zone in which the play is paused. Furthermore, in the present example, the distribution video is generated so as to include a scene (trigger scene) that has triggered suspension or pause of the play. This will be specifically described with reference to FIG. 7.

As illustrated, in the live event, various scenes occur as time passes. In the case of baseball, they are a hit scene, a home run scene, a good catch scene, a scoring scene, a fighting scene, and the like. Furthermore, they also include a scene lined up for recording, a scene where recording is achieved (such as 100th home run), and the like.

In the example illustrated in FIG. 7, scene 1, scene 2, scene 3, and scene 4 occur. Furthermore, scene 3 is a scene where a critical decision is made. Then, a scene where the video decision is made as a result of protesting the decision is scene 4. That is, scene 4 is a suspension scene in which the competition is temporarily suspended for video decision.

The scene analysis unit 23 of the video distribution server 2 specifies a scene type for each scene by performing analysis processing on the captured image (live through image).

The suspension scene is a time zone suitable for distributing the distribution video. Therefore, the video distribution server 2 determines the timing of entering the suspension scene as the execution timing of various types of processing (for example, processing of generating a distribution video) on the distribution video. That is, the video distribution server 2 determines the switching timing to the suspension scene as the execution timing.

Furthermore, the scene analysis unit 23 specifies that scene 4 which is the suspension scene is based on the video decision. In response to this, the distribution video determination unit 29 determines the distribution video so as to include the scene (play) that is the target of the video decision, that is, so as to include the trigger scene. Specifically, the scene (trigger scene) in which the play that is a factor (trigger) causing the suspension scene is generated is selected as the distribution target scene. Specifically, scene 3 is selected as the distribution target scene.

Note that there is a case where the distribution video does not need to be distributed immediately even when the suspension scene is entered. For example, there is a case of entering the suspension scene for the video decision, but the player of one team is protesting the decision result, and the user is watching the protesting situation with naked eyes in the venue. Since such a scene is a scene that the user wants to see, there is a case where such a distribution video is not viewed even if the distribution video is distributed to the user. Therefore, the execution timing of the distribution of the distribution video may be determined after the situation is settled, such as the timing when the protesting is ended. The processing start timing at this time is different from the switching timing to the suspension scene.

### 5-2. Second Example of Distribution Target

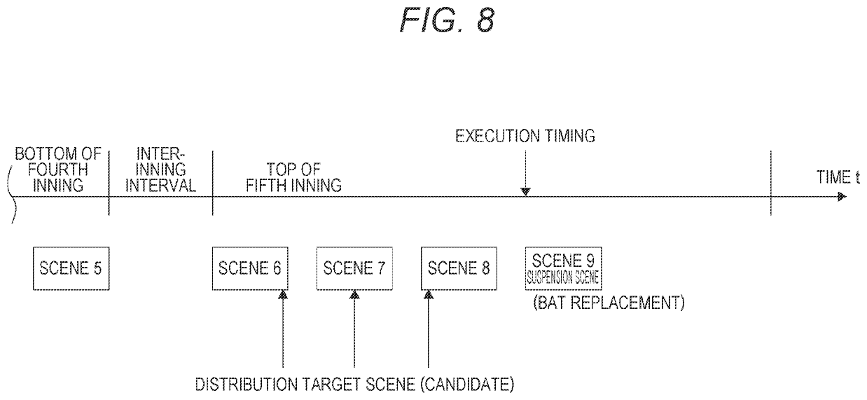

In the second example of the distribution target, it is decided which time segment (time zone) the timing at which the distribution of the distribution video is determined belongs to, and the distribution target scene is selected according to the time segment. This will be specifically described with reference to FIG. 8.

FIG. 8 illustrates a part of a flow of a baseball game, and the bottom of the fourth inning and the top of the fifth inning are illustrated as time segments in the figure. Furthermore, time segments of the inter-inning intervals provided between the fourth inning and the fifth inning are illustrated.

Scene 5 occurs at the bottom of the fourth inning. Furthermore, scene 6, scene 7, scene 8, and scene 9 occur in the top of the fifth inning.

Scene 9 is a scene in which the bat is being replaced due to the bat being broken, and is a suspension scene in which the competition is temporarily suspended.

The scene analysis unit 23 of the video distribution server 2 specifies a scene type for each scene by performing analysis processing on the captured image (live through image).

Scene 9 which is a suspension scene is a time zone suitable for distributing the distribution video similarly to the first example. Therefore, the video distribution server 2 determines the timing of entering the suspension scene as the execution timing of various types of processing for the distribution video. That is, the video distribution server 2 determines the switching timing to the suspension scene as the execution timing.

Similarly to the first example, the distribution video distributed here may select a scene (for example, scene 8) in which the play that has caused the occurrence of the suspension scene has occurred. However, it is conceivable that the scene in which the bat is broken is not a scene in which the user is interested.

In such a case, the distribution target scene may be selected from the scenes that occurred in the time segment to which the suspension scene belongs. For example, scene 9 is a bat replacement scene, and in a case where it is decided that the user is not satisfied even if the scene in which the bat is damaged is provided to the user, the distribution target scene may be selected from among scenes 6, 7, and 8 that occurred in the time segment of the top of the fifth inning in which scene 9 occurred. In other words, the scene included in the distribution video is selected according to the execution timing and the occurrence timing (occurrence time) of each scene. Furthermore, a scene having a short elapsed time from the occurrence time, that is, a scene that has occurred as recently as possible and is important is preferentially selected to generate the distribution video.

Note that a scene with high importance level may be selected from among a plurality of scenes in which the elapsed time from the occurrence time is within a predetermined time, or a scene may be selected in ascending order of the elapsed time from among a plurality of scenes in which the elapsed time is equal to or greater than a predetermined importance level.

Note that the distribution target scene may be selected from the scenes that occurred at the top of the fifth inning and the bottom of the fifth inning assuming that scene 9 is included in the “fifth inning” which is a time segment wider than the top of the fifth inning.

Alternatively, in a case where a game is classified into an early stage (first inning to third inning), a middle stage (fourth inning to sixth inning), a final stage (seventh inning to ninth inning), and an extension (tenth inning or more), since scene 9 is a scene that occurs in the time segment of the middle stage, the distribution target scene may be selected from among the scenes that occur in the middle stage (including scene 5 in FIG. 8).

Note that, in the first example, it has been described that it is not necessary to determine the distribution of the distribution video immediately even if the suspension scene occurs, but since the suspension scene in the present example is a bat replacement scene and there is a low possibility that the user gazes at the scene, the distribution of the distribution video may be determined immediately after entering the suspension scene.

In this way, even among same suspension scenes, the execution timing of the determination processing for the distribution video may be changed according to the content of the suspension scene, that is, according to the event situation information. As a result, it is possible to increase the possibility that the distribution video is distributed at an appropriate timing for the user.

Furthermore, instead of selecting the distribution target scene from among scenes 6, 7, and 8 that occur in the time segment of the top of the fifth inning, change processing on the importance level may be performed in order to make scenes 6, 7, and 8 easily included in the distribution video. For example, points may be added to the basic importance level of scene 6, scene 7, and scene 8 so that scene 6, scene 7, and scene 8 are more easily selected than scene 5.

### 5-3. Third Example of Distribution Target

In the third example of the distribution target, similarly to the second example, it is decided to which time segment (time zone) the timing at which the distribution of the distribution target is determined belongs, and the distribution target scene is selected according to the time segment. Then, a difference from the second example is that a time segment before the time segment to which the timing at which the distribution is determined belongs is selected as the distribution target.

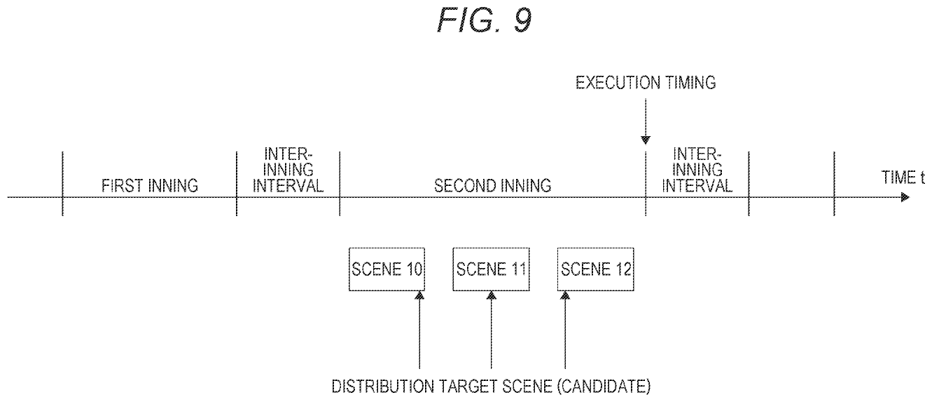

This will be specifically described with reference to FIG. 9.

FIG. 9 illustrates a part of a flow of a baseball game. In FIG. 9, the first inning (top and bottom) and the second inning (top and bottom) are illustrated as time segments, and a time segment of an inter-inning interval provided between the first inning and the second inning and a time segment of an inter-inning interval provided between the second inning and the third inning are illustrated.

Scene 10, scene 11, and scene 12 occur in the second inning. Then, the timing of entering the time segment of the inter-inning interval is determined as the execution timing of various types of processing on the distribution video. That is, the video distribution server 2 determines the switching timing to the time segment of the inter-inning interval as the execution timing.

Specifically, for example, the processing start control unit 27 determines the distribution of the distribution video at the timing when the time segment of the inter-inning interval arrives or at the timing when it is decided that the time segment of the inter-inning interval is likely to arrive.

The distribution video to be distributed here is distributed in response to arrival of the time segment of the inter-inning interval. In this case, each scene (scene 10, scene 11, and scene 12) that occur in the time segment (second inning) immediately before the time segment (the inter-inning interval) to which the timing at which the distribution of the distribution video is determined belongs is specified as a candidate of the distribution target scene, and the distribution target scene is selected from the specified scenes.

By selecting the distribution target scene in this manner, the highlight video obtained by collecting the scenes that occurred in the immediately preceding time segment is distributed as the distribution video, so that the user can appropriately grasp the game development of each inning.

### 5-4. Fourth Example of Distribution Target

In the fourth example of the distribution target, similarly to the second example and the third example, it is decided which time segment (time zone) the timing at which the distribution of the distribution target is determined belongs to, and the distribution target scene is selected according to the time segment. Then, in the fourth example, the range in which the distribution target scene is selected according to the type of the time segment is different from the second example and the third example.

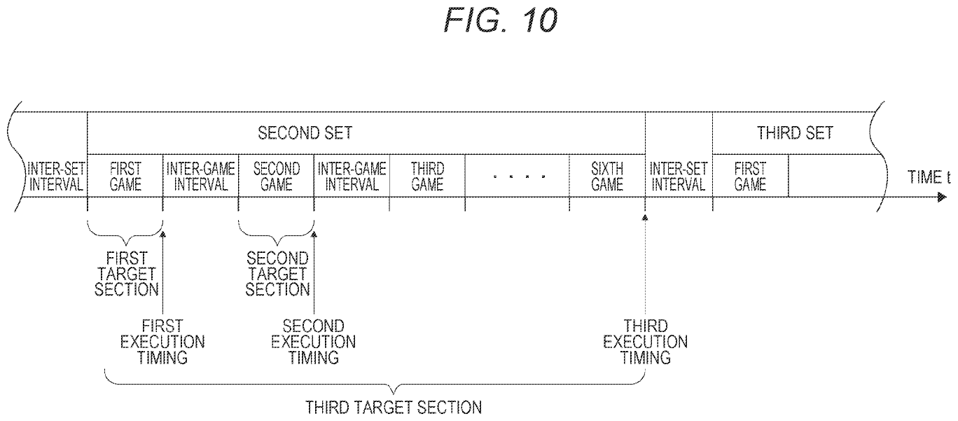

This will be specifically described with reference to FIG. 10.

FIG. 10 illustrates a part of a flow of a tennis game. In FIG. 10, a second set (first game to sixth game) and a third set are illustrated as time segments, and a time segment of an inter-set interval provided between the first set and the second set and a time segment of an inter-set interval provided between the second set and the third set are illustrated.

Moreover, in the time segment of the second set, time segments of the first game to the sixth game and time segments of inter-game intervals provided between the respective games are illustrated.

Although various scenes occur in each game, illustration is omitted in FIG. 10.

The inter-game interval provided between the first game and the second game of the second set is a time segment suitable for distribution of the distribution video. Therefore, the processing start control unit 27 determines the timing at which the time segment of the inter-game interval after the first game arrives as the timing (first execution timing) to execute various types of processing on the distribution video.

In the distribution video generated at the first execution timing, the first game which is the time segment immediately before is set as the first target section. That is, according to the arrival of the first execution timing, the highlight video collecting the scenes that occur in the first target section is distributed to the user terminal 5.

Furthermore, the inter-game interval provided between the second game and the third game of the second set is also a time segment suitable for distribution of the distribution video. The processing start control unit 27 determines the timing at which the time segment of the inter-game interval after the second game arrives as the timing (second execution timing) to execute various types of processing on the distribution video.

In the distribution video generated at the second execution timing, the second game which is the time segment immediately before is set as the second target section. That is, according to the arrival of the second execution timing, the highlight video collecting the scenes that occur in the second target section is distributed to the user terminal 5.

Note that this can be regarded as selecting a time segment included between time segments of the same type of interval as the distribution target section. That is, each scene (that is, each scene that occurs in the second game) that occurs between the time segment of the current interval (the inter-game interval consumed between the second game and the third game) and the time segment of the same type of interval consumed before the time segment (the inter-game interval consumed between the first game and the second game) is selected as the candidate for the distribution target scene.

Next, the distribution target in the inter-set interval will be described.

The inter-set interval set as the interval between the second set and the third set is determined as timing (third execution timing) at which various types of processing on the distribution video are executed.

When each scene that occurs in the time segment immediately before the time segment (inter-set interval) to which the timing (third execution timing) at which the distribution of the distribution video is determined belongs is specified as the candidate for the distribution target scene as in the third example, the distribution target scene is a scene that occurs in the sixth game of the second set.

However, since the inter-set interval is also a timing at which a player who wins the second set is determined, it may be preferable to distribute the highlight video of the second set to the user.

In this example, since the time segment included between the time segments of the same type of interval is selected as the distribution target section, the time segment between the inter-set interval between the second set and the third set and the inter-set interval between the first set and the second set, that is, each scene that occurs between the first game and the sixth game of the second set is selected as the candidate for the distribution target scene.

Therefore, since the distribution video generated by the arrival of the third execution timing is the highlight video of the second set, it is possible to distribute an appropriate distribution video to the user.

### 6. Processing Example

Processing executed by the video distribution server 2 to implement each example described above will be described with reference to the attached drawings. Note that each processing described below is executed by an arithmetic processing unit such as a CPU included in the video distribution server 2. In the following description, an arithmetic processing unit such as a CPU will be simply referred to as a “control unit”.

### 6-1. First Processing Example

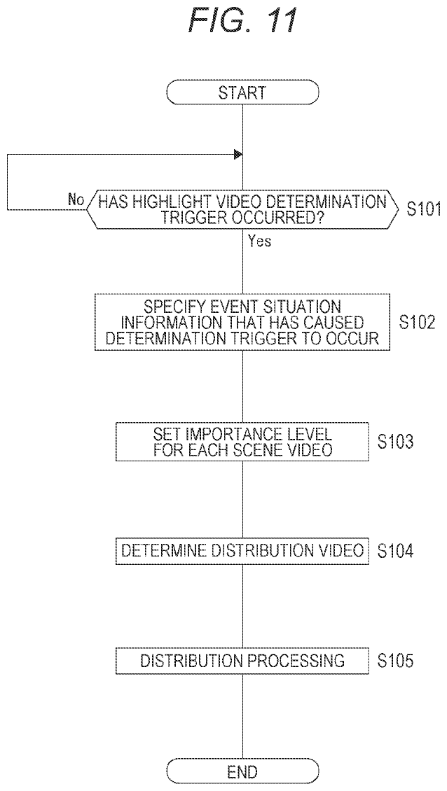

A first processing example is executed when a highlight video is delivered to the user terminal 5 on the basis of event situation information such as a progress situation of a game. This will be specifically described with reference to FIG. 11.

In step S101, the control unit decides whether or not a highlight video determination trigger has occurred. The highlight video determination trigger is a flag generated (set) in a case where the processing start control unit 27 monitors the event situation information and decides that the timing to generate and distribute the highlight video has come. Alternatively, the highlight video determination trigger is set to ON in a case where it is detected that the user has performed an operation for viewing the highlight video.

The control unit repeats the processing of step S101 until a highlight video determination trigger is generated.

In a case where it is decided that the highlight video determination trigger has occurred, the control unit specifies the event situation information corresponding to the highlight video determination trigger in step S102.

Moreover, in step S103, the control unit sets the importance level for each scene video. The importance level is set according to, for example, the event situation information corresponding to the highlight video determination trigger. For example, in baseball, the importance level of a scene in which a batter misses a ball thrown by a pitcher is usually not high. However, in a case where a suspension scene comes due to one team protesting against the judgment of the referee for the play, the importance level of the scene in which the ball is missed is set high.

Subsequently, in step S104, the control unit determines a distribution video by selecting a scene video or the like.

In step S105, the control unit performs distribution processing of the determined distribution video.

As a result, the distribution video is distributed to the user terminal 5 used by the user.

### 6-2. Second Processing Example

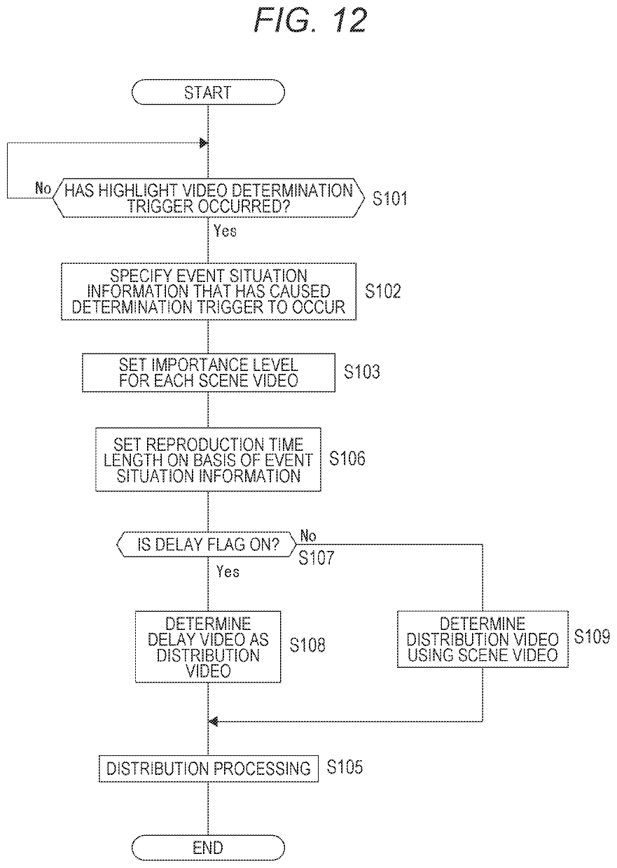

The second processing example is processing executed in a case where the reproduction time length of the distribution video is set on the basis of the event situation information and the distribution video is distributed. This will be specifically described with reference to FIG. 12. Note that processing similar to that in the first processing example is denoted by the same step numbers, and description thereof will be omitted as appropriate.

In step S101, the control unit decides whether or not a highlight video determination trigger has occurred, and in a case where it is decided that the highlight video determination trigger has occurred, the control unit specifies event situation information that has caused the determination trigger to occur in step S102.

Moreover, in step S103, the control unit sets the importance level for each scene video.

Subsequently, in step S106, the control unit sets the reproduction time length on the basis of the event situation information. The reproduction time length set here is set according to the scene type that is the event situation information. Specifically, for example, in a case where the distribution video is distributed in the suspension scene, the reproduction time length is set according to the type of the suspension scene. At this time, the average suspension time may be calculated for each type of the suspension scene, and the reproduction time length may be set on the basis of the calculated suspension time, or the reproduction time length may be set in consideration of not only the type of the suspension scene but also event situation information indicating the flow of the entire game and event situation information indicating the progress of the game.

In step S107, the control unit checks the delay flag. The delay flag is a flag set to ON when distribution of the delay video is determined. For example, in a case where there is no scene whose importance level is higher than a predetermined threshold value, the delay flag is set to ON.

In a case where the delay flag is ON, instead of determining the video obtained by connecting the scene videos as the distribution video, the control unit determines a delay video delayed from the real-time video by a predetermined second as the distribution video in step S108.

In a case where the delay flag is OFF, in step S109, the control unit determines a video obtained by selecting or connecting scene videos as a distribution video.

In step S105, the control unit performs distribution processing of the determined distribution video.

### 6-3. Third Processing Example

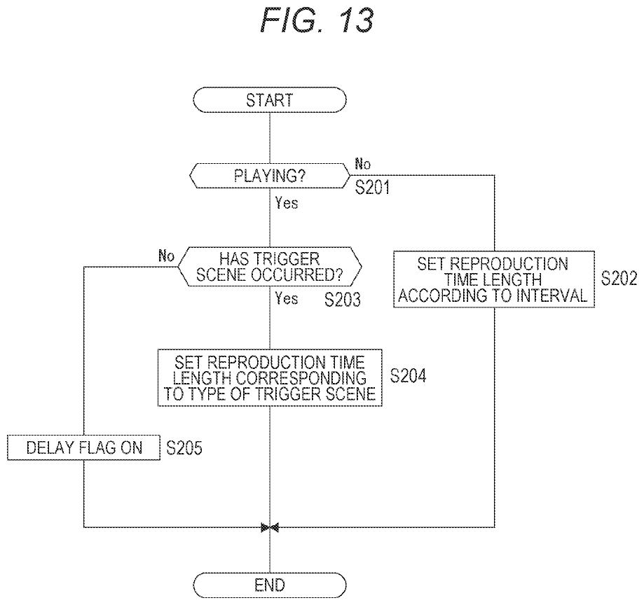

A third processing example is processing executed in a case where the reproduction time length set when the distribution of the distribution video is determined using at least a part of the information of the tag information, the time code information, and the event situation information corresponds to a scene that triggers the distribution of the distribution video, that is, a trigger scene (a scene in which the play that has caused the suspension scene). This will be specifically described with reference to FIG. 13.

In step S201, the control unit decides whether or not the live event is playing. In a case where the progress of the live event is suspended or an interval in a preset time segment is consumed, it is decided that the live event is not playing.

In a case where it is decided that the live event is not playing, the control unit sets a reproduction time length according to the interval (or suspension scene) in step S202. As a result, the distribution video having a length just enough to be viewed at the interval time is provided to the user.

On the other hand, in a case where it is decided that the live event is playing, the control unit decides whether or not a trigger scene has occurred in step S203.

In a case where it is decided that the trigger scene has occurred, the control unit sets the reproduction time length according to the scene type of the trigger scene in step S204. For example, the suspension time in a case where the game is suspended may be determined according to the content of the play that triggers the suspension. In step S204, since the reproduction time length is set according to the scene type of the trigger scene, the reproduction time length of the distribution video is set according to the content of the play that has triggered the suspension, and an appropriate distribution moving image can be provided to the user.

On the other hand, in a case where it is decided that the trigger scene has not occurred, the control unit sets the delay flag to ON in step S205. As a result, in a case where there is no distribution video to be distributed to the user or the like, the delay video can be provided to the user.

### 6-4. Fourth Processing Example

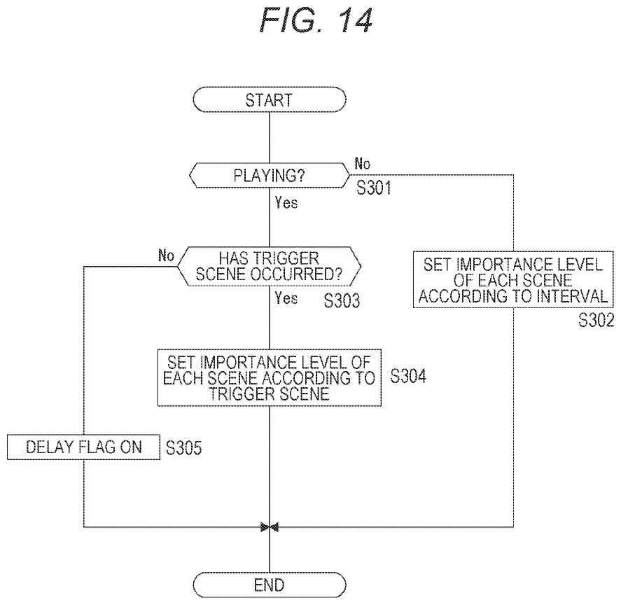

A fourth processing example is processing of setting the importance level to each scene video according to the scene type of the trigger scene in a case where distribution of the distribution video is determined. That is, since the importance level is set according to the relationship between the trigger scene and the scene video, the scene video having a deeper relationship with the trigger scene is set to have a higher importance level. This will be specifically described with reference to FIG. 14.

In step S301, the control unit decides whether or not the live event is playing. In a case where the progress of the live event is suspended or an interval in a preset time segment is consumed, it is decided that the live event is not playing.

In a case where it is decided that the live event is not playing, in step S30, the control unit sets the importance level of each scene video according to the type of interval (or suspension scene) or the like. As a result, it is possible to provide the user with an appropriate distribution video for each interval or suspension scene.

On the other hand, in a case where it is decided that the live event is playing, the control unit decides whether or not a trigger scene has occurred in step S303.

In a case where it is decided that the trigger scene has occurred, the control unit sets the importance level to each scene video according to the scene type of the trigger scene in step S304. For example, the scene video highly related to the trigger scene is set with high importance level, and is easily included in the distribution video. On the other hand, the scene video having low relevance to the trigger scene is set with low importance level, and is hardly included in the distribution video.

That is, it is possible to provide the user with an appropriate distribution video for more deeply understanding what has occurred in the trigger scene.

On the other hand, in a case where it is decided that the trigger scene has not occurred, the control unit sets the delay flag to ON in step S305. As a result, in a case where there is no distribution video to be distributed to the user or the like, the delay video can be provided to the user.

<7. Modification>

In each example described above, an example in which the time length setting unit 28 sets the reproduction time length of the distribution video has been described. The present invention is not limited thereto, and the user may select (input) the reproduction time length. The viewing time suitable for the user is not necessarily the same. By allowing the user to select the reproduction time length, an appropriate distribution video can be provided to the user.

Note that, in a case where the length of time for viewing the distribution video is acquired as the viewing history of the user, the reproduction time length may be set according to the viewing history.

Furthermore, the position information of the user terminal 5 owned by the user may be acquired, and the reproduction time length may be set on the basis of the position information. For example, in a case where it is estimated that the user has moved to the toilet or the store on the basis of the position information of the user terminal 5, the reproduction time length may be set to be short in consideration of the time until the user returns to the seat.

In each example described above, an example in which the distribution timing and the generation timing of the distribution video are determined according to the event situation information has been described, but other examples are also conceivable. For example, it is assumed that every time a specific scene occurs in a live event, a scene video for the scene is generated and accumulated in the video server 3. At this time, a scene video is appropriately selected according to the event situation information and distributed to the user as a distribution video, and in a case where the distribution timing has not arrived for a predetermined time, and in a case where there is a scene video that has not been distributed to the user terminal 5 for a predetermined time length or more among the accumulated scene videos, a scene video matching the liking/preference information of the user may be selected and provided to the user.

In each example described above, an example in which the timing of distributing the distribution video to the user is determined according to the event situation information has been described. However, the distribution timing of the distribution video may be determined according to reception of predetermined information from the user terminal 5.

For example, in response to the user activating the user terminal 5 such as a mobile phone and activating an application software for enjoying various services provided by the video distribution system 1, the user's intention of desiring to view the distribution video may be estimated, and the selection processing or combination processing of the scene videos for generating the distribution video may be executed to distribute the distribution video.

<8. Summary>

As described in each example described above, the video distribution server 2 as the information processing device includes the distribution video determination unit 29 that determines the distribution video on the basis of the event situation information indicating the situation of the live event at the execution time of the determination processing on the distribution video.

The determination processing includes processing of determining generation of a scene video for a scene in response to occurrence of the scene that is likely to be distributed to the user, processing of determining selection of one or a plurality of scene videos from a plurality of scene videos to generate a distribution video, processing of determining generation of a distribution video using the selected one or plurality of scene videos, processing of determining distribution of the generated distribution video, processing of determining list display of distribution videos, and the like.

Furthermore, for example, in the case of a sports game, the event situation information is a progress situation of the game, a score, a scoring situation, a content or a type of a scene, a situation of a player, a situation of a tool used by a player, a situation of an audience, or the like.

By determining the distribution video according to the situation of the live event at the time when various types of determination processing are executed, it is possible to distribute an appropriate distribution video according to the situation to the user each time.

The distribution video determination unit 29 in the video distribution server 2 may generate the distribution video according to the event situation information.

The distribution video may be generated by performing processing of cutting out and processing of connecting videos of specific scenes from videos of the live event captured by the generation processing execution time, or may be generated by performing processing of selecting one or a plurality of scene videos from the scene videos as partial moving images already generated and processing of connecting the scene videos.

As a result, the distribution video is generated as an appropriate distribution video according to the situation of the live event at the execution time of various types of determination processing.

The distribution video determination unit 29 in the video distribution server 2 may determine the scene included in the distribution video according to the event situation information.

That is, the scene to be distributed is determined from the various scenes so far according to the situation of the live event at the execution time of the various types of determination processing.

Therefore, the distribution video is determined and distributed so as to include an appropriate scene according to the situation of the live event.

The video distribution server 2 may include the importance level setting unit 25 that sets an importance level for each scene on the basis of the event situation information, and the distribution video determination unit 29 may determine a scene on the basis of the importance level.

As a result, for example, the importance level corresponding to the event situation is set even for a similar scene.

Therefore, for example, an appropriate distribution video according to the game situation can be provided to the user.

The distribution video determination unit 29 in the video distribution server 2 may select the distribution video from a plurality of candidate videos (for example, scene videos) selectable as the distribution video according to the event situation information.

As a result, at the time of distribution, it is only necessary to determine the distribution video from the already generated candidate videos.

Therefore, it is possible to reduce a processing load from determination of distribution to distribution of the distribution video.

The video distribution server 2 may include the importance level setting unit 25 that sets the importance level of each of the plurality of candidate videos on the basis of the event situation information, and the distribution video determination unit 29 may select the distribution video on the basis of the importance level.

As a result, according to the event situation, for example, the importance level is set to the candidate video according to the progress of the game or the game development.

Therefore, it is possible to provide the user with an appropriate distribution video according to the game situation.

In the video distribution server 2, the event situation information may be progress information indicating a degree of progress with respect to the total time length of the live event.

The progress information may be, for example, elapsed time information from the start time of the live event, information regarding a time segment set for each predetermined time length in sports, or a consumed rate of the event in the live event.

The information regarding the predetermined time segment in sports is, for example, information on the first half (45 minutes), the second half (45 minutes), or the like in soccer, or the like. Furthermore, the information may be interval information (for example, halftime provided during the entire second half, or the like) provided for each section.

It is conceivable that the appropriate distribution video varies depending on the degree of progress of the live event. According to this configuration, since the distribution video is determined according to the degree of progress, it is possible to provide the distribution video with high value for the user.

In the video distribution server 2, the event situation information may be information regarding a consuming or consumed time segment among time segments determined in advance in the live event, and the distribution video determination unit 29 may determine the distribution video according to the last consumed time segment or the consuming time segment.

The time segment is, for example, information on the top of the first inning, the bottom of the seventh inning, or the like in baseball, information on the first inning (top and bottom of the first inning) or the like, information on a first half (first inning to third inning), a middle stage (fourth inning to sixth inning), a final stage (seventh inning to ninth inning), and the like and information on a second set, a third set, or the like in volleyball.

Then, for example, in a case where the distribution of the distribution video is determined during consumption of the bottom of the fifth inning in baseball, the distribution video for the bottom of the fifth inning being consumed may be distributed, the distribution video for the fifth inning being consumed (that is, the distribution video including the scenes of the top of the fifth inning and the bottom of the fifth inning) may be distributed, the distribution video for the top of the fifth inning consumed last may be distributed, or the distribution video for the fourth inning consumed last (that is, the fifth inning is being consumed) may be distributed.

Since the distribution video is determined according to the degree of progress of the live event, it is possible to provide the distribution video with high value for the user.

In the video distribution server 2, the event situation information may be information regarding the time segment of the interval in the live event, and the distribution video determination unit 29 may determine the distribution video according to the time segment consumed immediately before the interval.

The time of the interval can be considered as an appropriate time zone for distributing the distribution video because the event to be viewed is inactive. Since the distribution video distributed in the time zone of the interval is for the immediately preceding time segment, the highlight moving image or the like can be distributed to the user.

In the video distribution server 2, the event situation information may be information of the scene type of the scene corresponding to the determination processing in the live event.

As a result, the distribution video is determined according to the type or the like of the scene occurring at the execution time of the determination processing.

That is, if the scene corresponding to the determination processing is a suspension scene caused by an important trigger scene, the scene video is selected and distributed as the distribution video so as to include the trigger scene or the related scene, and if the scene is a suspension scene in which the trigger scene does not exist, the scene video selected from the game development so far or the like is selected and distributed as the distribution video. As a result, it is possible to provide the user with an appropriate distribution video according to the scene type or the like.

The video distribution server 2 may include the importance level setting unit 25 that sets an importance level for a trigger scene (for example, a scene in which a play that is a cause of occurrence of a suspension scene has occurred) that is a trigger for execution of the determination processing on the distribution video, and the distribution video determination unit 29 may determine the distribution video by selecting a scene including the trigger scene on the basis of the importance level.

In a case where the importance level of the trigger scene, which is the scene that triggered the distribution of the distribution video, is high, the distribution video including the trigger scene is generated and distributed.

As a result, it is possible to distribute a replay video of an important scene or the like to the user with occurrence of the important scene as a trigger. That is, in a case where the user has missed an important scene or the like, it is possible to distribute the distribution video satisfying the request of the user who wants to see the important scene again, and thus, it is possible to improve convenience.

The distribution video determination unit 29 in the video distribution server 2 may determine the scene on the basis of the occurrence time and the importance level of each scene.

In a case where a scene other than the trigger scene is selected and the distribution video is generated, not only the importance level of the scene but also the occurrence time is taken into consideration.

s For example, a trigger scene when the distribution video is distributed according to a scene of racket exchange in tennis is a scene of racket exchange. At this time, since the scene of the racket exchange is not an important scene, the scene to be included in the distribution video is selected from among the scenes that occurred before the racket exchange according to the importance level and the occurrence time. Therefore, for example, it is conceivable to generate the distribution video by preferentially selecting a scene having a short elapsed time from the occurrence time, that is, a scene that has occurred as recently as possible and is important.

As a result, a distribution video suitable for the user to grasp the flow of the current game again is distributed to the user, and the convenience of the user can be improved.

The video distribution server 2 may include the time length setting unit 28 that sets the reproduction time length of the distribution video on the basis of the event situation information, and the distribution video determination unit 29 may determine the distribution video on the basis of the reproduction time length.

The time length allocated to the viewing of the distribution video may vary depending on the situation of the live event. Specifically, taking soccer as an example, an appropriate reproduction time length of the distribution video to be distributed to the user is different between a case where the distribution video is browsed in a relatively long free time such as half time and a case where the distribution video is browsed in a relatively short time such as while the progress of the game is suspended due to the yellow card.

According to this configuration, the reproduction time length is set on the basis of the event situation information.

Therefore, it is possible to distribute the distribution video having an appropriate length for each distribution timing.

The time length setting unit 28 in the video distribution server 2 may set the reproduction time length of the distribution video to be distributed in a time segment of an interval in the live event according to a length of the interval.

For the distribution video to be distributed at the interval, it is desirable to provide the distribution video having a reproduction time length according to the time length of the interval to the user.

According to this configuration, it is possible to provide the user with the distribution video having a length suitable for viewing during the interval.

The video distribution server 2 may include the processing start control unit 27 that determines the execution timing of the determination processing according to the event situation information.

As a result, execution timings of processing of determining generation of a scene video as a partial moving image that can be included in a distribution video, processing of determining selection of one or a plurality of scene videos from a plurality of scene videos, processing of determining generation of a distribution video, processing of determining distribution of a distribution video, processing of determining list display of distribution videos, and the like are determined according to the situation of the live event.

Therefore, since various determinations are made according to the situation of the live event, and the distribution video is generated and distributed to the user, it is possible to provide the user with an appropriate distribution video according to the situation.

The processing start control unit 27 in the video distribution server 2 may determine the switching timing of the time segment determined in advance in the live event as the execution timing.

As a result, it is possible to distribute the distribution video and the like at a timing suitable for the user.

Therefore, for example, the user can view the distribution video by efficiently using the interval time, and the convenience can be improved.

The processing start control unit 27 in the video distribution server 2 may determine the execution timing according to the scene type of the scene that occurs in the live event.

As a result, it is possible to distribute the distribution video at an appropriate timing according to the scene type.

Therefore, it is possible to provide an appropriate distribution video to the user at an appropriate timing.

The video distribution server 2 may generate the event situation information on the basis of the captured image obtained by capturing the live event.

The event situation information is various types of information indicating the situation of the live event. According to this configuration, the situation of the live event is estimated by analyzing the captured image. That is, the estimation processing is executed as to what kind of scene the currently captured scene is.

As a result, the event situation can be appropriately estimated without acquiring the event situation information from the external terminal, and the distribution video can be distributed to the user.

The information processing method executed by the video distribution server 2 includes a step of determining the distribution video on the basis of the event situation information indicating the situation of the live event at the execution time of the determination processing on the distribution video.

Furthermore, the program to be executed by the video distribution server 2 includes processing of determining the distribution video on the basis of the event situation information indicating the situation of the live event at the execution time of the determination processing on the distribution video.

With such an information processing method and program, it is possible to provide the user with the distribution video according to the situation of the live event.

Note that the effects described in the present specification are merely examples and are not limited, and other effects may be provided.

Furthermore, the above-described examples can be combined in any manner as long as the combination is not impossible.

<9. Present Technology>

Note that the present technology can also adopt the following configurations.

(1)

An information processing device including

a distribution video determination unit that determines a distribution video on the basis of event situation information indicating a situation of a live event at an execution time of determination processing on the distribution video.

(2)

The information processing device according to (1),

in which the distribution video determination unit generates the distribution video according to the event situation information.

(3)

The information processing device according to (2),

in which the distribution video determination unit determines a scene included in the distribution video according to the event situation information.

(4)

The information processing device according to (3), further including

an importance level setting unit that sets an importance level for the scene on the basis of the event situation information,

in which the distribution video determination unit determines the scene on the basis of the importance level.

(5)

The information processing device according to any one of (1) to (4),

in which the distribution video determination unit selects the distribution video from a plurality of candidate videos selectable as the distribution video according to the event situation information.

(6)

The information processing device according to (5), further including

an importance level setting unit that sets an importance level of each of the plurality of candidate videos on the basis of the event situation information,

in which the distribution video determination unit selects the distribution video on the basis of the importance level.

(7)

The information processing device according to any one of (1) to (6),

in which the event situation information is progress information indicating a degree of progress with respect to a total time length of the live event.

(8)

The information processing device according to any one of (1) to (6),

in which the event situation information is information regarding a consuming or consumed time segment among time segments determined in advance in the live event, and

the distribution video determination unit determines a distribution video according to a last consumed time segment or a consuming time segment.

(9)

The information processing device according to any one of (1) to (6),

in which the event situation information is information regarding a time segment of an interval in the live event, and

the distribution video determination unit determines a distribution video according to a time segment consumed immediately before the interval.

(10)

The information processing device according to any one of (1) to (9),

in which the event situation information is information of a scene type of a scene corresponding to the determination processing in the live event.

(11)

The information processing device according to any one of (1) to (10), further including

an importance level setting unit that sets an importance level to a trigger scene that is a trigger for execution of the determination processing on the distribution video,

in which the distribution video determination unit determines the distribution video by selecting a scene including the trigger scene on the basis of the importance level.

(12)

The information processing device according to (11),

in which the distribution video determination unit determines the scene on the basis of an occurrence time and the importance level of the scene.

(13)

The information processing device according to any one of (1) to (12), further including

a time length setting unit that sets a reproduction time length of the distribution video on the basis of the event situation information,

in which the distribution video determination unit determines the distribution video on the basis of the reproduction time length.

(14)

The information processing device according to (13),

in which the time length setting unit sets the reproduction time length of the distribution video to be distributed in a time segment of an interval in the live event according to a length of the interval.

(15)

The information processing device according to (1) to (14), further including

a processing start control unit that determines an execution timing of the determination processing according to the event situation information.

(16)

The information processing device according to (15),

in which the processing start control unit determines a switching timing of a time segment determined in advance in the live event as the execution timing.

(17)

The information processing device according to (15),

in which the processing start control unit determines the execution timing according to a scene type of a scene that occurs in the live event.

(18)

The information processing device according to (1) to (17),

in which the event situation information is generated on the basis of a captured image obtained by capturing the live event.

(19)

An information processing method executed by an information processing device, the information processing method including

a step of determining a distribution video on the basis of event situation information indicating a situation of a live event at an execution time of determination processing on the distribution video.

(20)

a program causing a computer to execute

processing of determining a distribution video on the basis of event Situation information indicating a situation of a live event at an execution time of determination processing on the distribution video.

### REFERENCE SIGNS LIST

2 Video distribution server
25 Importance level setting unit
26 Event situation information acquisition unit
27 Processing start control unit
28 Time length setting unit
29 Distribution video determination unit

1. An information processing device comprising
a distribution video determination unit that determines a distribution video on a basis of event situation information indicating a situation of a live event at an execution time of determination processing on the distribution video.

2. The information processing device according to claim 1,
wherein the distribution video determination unit generates the distribution video according to the event situation information.

3. The information processing device according to claim 2,
wherein the distribution video determination unit determines a scene included in the distribution video according to the event situation information.

4. The information processing device according to claim 3, further comprising
an importance level setting unit that sets an importance level for the scene on a basis of the event situation information,
wherein the distribution video determination unit determines the scene on a basis of the importance level.

5. The information processing device according to claim 1,
wherein the distribution video determination unit selects the distribution video from a plurality of candidate videos selectable as the distribution video according to the event situation information.

6. The information processing device according to claim 5, further comprising
an importance level setting unit that sets an importance level of each of the plurality of candidate videos on a basis of the event situation information,
wherein the distribution video determination unit selects the distribution video on a basis of the importance level.

7. The information processing device according to claim 1,
wherein the event situation information is progress information indicating a degree of progress with respect to a total time length of the live event.

8. The information processing device according to claim 1,
wherein the event situation information is information regarding a consuming or consumed time segment among time segments determined in advance in the live event, and
the distribution video determination unit determines a distribution video according to a last consumed time segment or a consuming time segment.

9. The information processing device according to claim 1,
wherein the event situation information is information regarding a time segment of an interval in the live event, and
the distribution video determination unit determines a distribution video according to a time segment consumed immediately before the interval.

10. The information processing device according to claim 1,
wherein the event situation information is information of a scene type of a scene corresponding to the determination processing in the live event.

11. The information processing device according to claim 1, further comprising
an importance level setting unit that sets an importance level to a trigger scene that is a trigger for execution of the determination processing on the distribution video,
wherein the distribution video determination unit determines the distribution video by selecting a scene including the trigger scene on a basis of the importance level.

12. The information processing device according to claim 11,
wherein the distribution video determination unit determines the scene on a basis of an occurrence time and the importance level of the scene.

13. The information processing device according to claim 1, further comprising
a time length setting unit that sets a reproduction time length of the distribution video on a basis of the event situation information,
wherein the distribution video determination unit determines the distribution video on a basis of the reproduction time length.

14. The information processing device according to claim 13,
wherein the time length setting unit sets the reproduction time length of the distribution video to be distributed in a time segment of an interval in the live event according to a length of the interval.

15. The information processing device according to claim 1, further comprising
a processing start control unit that determines an execution timing of the determination processing according to the event situation information.

16. The information processing device according to claim 15,
wherein the processing start control unit determines a switching timing of a time segment determined in advance in the live event as the execution timing.

17. The information processing device according to claim 15,
wherein the processing start control unit determines the execution timing according to a scene type of a scene that occurs in the live event.

18. The information processing device according to claim 1,
wherein the event situation information is generated on a basis of a captured image obtained by capturing the live event.

19. An information processing method executed by an information processing device, the information processing method comprising
a step of determining a distribution video on a basis of event situation information indicating a situation of a live event at an execution time of determination processing on the distribution video.

20. A program causing a computer to execute
processing of determining a distribution video on a basis of event situation information indicating a situation of a live event at an execution time of determination processing on the distribution video.
